(19) United States
(12) Patent Application Publication
(10) Pub. No.: US 2017/0309958 A1
(43) Pub. Date: Oct. 26, 2017

(54) ELECTROLYTIC SOLUTION FOR SODIUM-ION SECONDARY BATTERY AND SODIUM-ION SECONDARY BATTERY

(71) Applicant: Sumitomo Electric Industries, Ltd., Osaka-shi (JP)

(72) Inventors: Shoichiro Sakai, Osaka-shi (JP); Koji Nitta, Osaka-shi (JP); Atsushi Fukunaga, Osaka-shi (JP); Eiko Imazaki, Osaka-shi (JP); Masahiro Aoki, Shunan-shi (JP)

(73) Assignee: Sumitomo Electric Industries, Ltd., Osaka-shi (JP)

(21) Appl. No.: 15/517,456

(22) PCT Filed: Oct. 5, 2015
(86) PCT No.: PCT/JP2015/078134

§ 371 Date: Apr. 6, 2017

(30) Foreign Application Priority Data
Oct. 8, 2014 (JP) 2014-207073

(51) Int. Cl. H01M 10/0566; H01M 10/0561; H01M 4/36

(52) U.S. Cl. CPC H01M 10/0566; H01M 4/36; H01M 10/0561

(57) ABSTRACT

Provided are an electrolytic solution for sodium-ion secondary battery, the solution having sodium-ion conductivity, and including a sodium salt and a non-aqueous solvent, wherein the non-aqueous solvent includes a fluorophosphate ester and propylene carbonate, and a content of the fluorophosphate ester in the non-aqueous solvent is 5 to 50 mass %; and a sodium-ion secondary battery including the same.

### TECHNICAL FIELD

The present invention relates to an electrolytic solution for sodium-ion secondary battery including a fluorophosphate ester and propylene carbonate; and a sodium-ion secondary battery including the same.

### BACKGROUND ART

In recent years, techniques for converting natural energy such as solar light and wind power into electric energy have attracted attention. Further, there has been growing demand for a lithium-ion secondary battery, a lithium-ion capacitor, and the like as electric storage device that can store much electric energy.

Since the lithium-ion secondary battery and the lithium-ion capacitor use an organic electrolytic solution having a low flash point, ensuring flame retardancy is also one of their issues. From the viewpoint of ensuring flame retardancy, Patent Literature 1 proposes that a phosphate such as a fluorophosphate ester is used as a solvent of an electrolytic solution for a lithium-ion secondary battery.

Meanwhile, the price of a lithium resource has been increasing due to the expansion of a market for an electric storage device. A sodium resource is cheaper than the lithium resource. Therefore, a sodium-ion battery including a sodium ion as a carrier ion has been studied (e.g., Patent Literature 2). The sodium-ion battery includes a positive electrode, a negative electrode, and a sodium ion-conductive non-aqueous electrolytic solution.

### CITATION LIST

### Patent Literature

Patent Literature 1: Japanese Unexamined Patent Publication No. 2011-187410
Patent Literature 2: Japanese Unexamined Patent Publication No. 2013-48077

### SUMMARY OF INVENTION

### Technical Problem

Patent Literature 1 teaches that a phosphate such as a fluorophosphate ester has high flame retardancy, but tends to deteriorate battery performance. Actually, even when a fluorophosphate ester is used as a solvent of an electrolytic solution for a lithium-ion secondary battery, a cycle characteristic and/or a rate characteristic cannot be sufficiently improved depending on the composition of other components contained in the electrolytic solution. Further, there is also a case where it is difficult to perform charge and discharge per se.

The sodium-ion secondary battery expected to be produced at lower cost is very advantageous if both a cycle characteristic and a rate characteristic are achieved while high flame retardancy is ensured.

It is therefore an object of the present invention to provide an electrolytic solution that has high flame retardancy and can improve the cycle characteristic and rate characteristic of a sodium-ion secondary battery, and a sodium secondary battery including the same.

### Solution to Problem

One aspect of the present invention relates to an electrolytic solution for sodium-ion secondary battery, the solution having sodium-ion conductivity, and including a sodium salt and a non-aqueous solvent, wherein

the non-aqueous solvent includes a fluorophosphate ester and propylene carbonate, and

a content of the fluorophosphate ester in the non-aqueous solvent is 5 to 50 mass %.

Another aspect of the present invention relates to a sodium-ion secondary battery including: a positive electrode; a negative electrode; a separator interposed between the positive electrode and the negative electrode; and the electrolytic solution described above.

### Advantageous Effects of Invention

According to the present invention, it is possible to improve the cycle characteristic and rate characteristic (large-current discharge characteristic) of a sodium-ion secondary battery while ensuring high flame retardancy of an electrolytic solution.

### BRIEF DESCRIPTION OF DRAWING

FIG. 1 is a longitudinal sectional view schematically showing a sodium-ion secondary battery of one embodiment of the present invention.

### DESCRIPTION OF EMBODIMENTS

### Description of Embodiments of the Invention

First, features of embodiments of the present invention will be listed and described.

An electrolytic solution for a sodium-ion secondary battery of one embodiment of the present invention is (1) an electrolytic solution has sodium-ion conductivity includes a sodium salt and a non-aqueous solvent. Here, the non-aqueous solvent includes a fluorophosphate ester and propylene carbonate (PC). A content of the fluorophosphate ester in the non-aqueous solvent is 5 to 50 mass %. The use of such a non-aqueous solvent as a solvent of the electrolytic solution for a sodium-ion secondary battery makes it possible to significantly improve the flame retardancy of the electrolytic solution (finally improve the flame retardancy of a sodium-ion secondary battery) in spite of the fact that the electrolytic solution contains PC having low flame retardancy.

On the other hand, when a non-aqueous solvent containing a fluorophosphate ester is used as a solvent of an electrolytic solution for a lithium-ion secondary battery, the cycle characteristic and/or rate characteristic of a lithium-ion secondary battery tend to be impaired, and there is also a case where it is difficult to perform charge and discharge per se. Since the solvation energy between a lithium ion and a fluorophosphate ester is large, the lithium ion is occluded (or intercalated) in a negative-electrode active material in a solvated state during charge. As a result, it is considered that an unstable solid electrolyte interface (SEI) film is formed due to the occurrence of decomposition of the electrolytic solution so that resistance increases. Since the formation of the SEI film becomes remarkable as charge and discharge proceed, it is considered that a cycle characteristic is deteriorated. When the solvation energy between a lithium ion and a fluorophosphate ester is reduced in order to improve a cycle characteristic, the viscosity of the electrolytic solution tends to increase so that a rate characteristic is impaired due to a reduction in ion conductivity. Further, when an electrolytic solution containing PC is used in a lithium-ion secondary battery, the electrolytic solution is decomposed before the battery reaches the potential at which lithium ions are occluded (or intercalated) in a negative-electrode active material so that charge and discharge cannot be performed.

According to this embodiment of the present invention, as described above, a non-aqueous solvent containing 5 to 50 mass % of a fluorophosphate ester and PC is used as a solvent of the electrolytic solution for the sodium-ion secondary battery. Since a sodium ion has a larger ion radius than a lithium ion, the solvation energy between the sodium ion and a fluorophosphate ester is lower than that between a lithium ion and a fluorophosphate ester due to a lower charge density of the sodium ion. Therefore, intercalation of sodium ions in a negative electrode can smoothly be performed so that the side reaction of the electrolytic solution is inhibited. Therefore, a reduction in capacity resulting from repeated charge and discharge is inhibited even when charge and discharge are repeated so that a high cycle characteristic is achieved. Since the use of PC as a solvent of the electrolytic solution for the sodium-ion secondary battery makes it possible to reduce the viscosity of the electrolytic solution, high ion conductivity is easily ensured and a high rate characteristic can be achieved. Further, even when a sodium-ion secondary battery uses PC as a solvent of its electrolytic solution, the decomposition of the electrolytic solution can be inhibited.

(2) In a preferable embodiment, the electrolytic solution of this embodiment does not have a flash point. The electrolytic solution of this embodiment contains, as a solvent, a non-aqueous solvent containing 5 to 50 mass % of a fluorophosphate ester. Therefore, the electrolytic solution of this embodiment can ensure high flame retardancy and can finally enhance the flame retardancy of a sodium-ion secondary battery. As a result, the electrolytic solution of this embodiment can enhance the safety of a sodium-ion secondary battery.

(3) The fluorophosphate ester is preferably a polyfluoroalkylphosphate having 1 to 3 polyfluoroalkyl groups. Here, each of the 1 to 3 polyfluoroalkyl groups is a difluoroalkyl group having 1 to 3 carbon atoms, a trifluoroalkyl group having 1 to 3 carbon atoms, or a tetrafluoroalkyl group having 2 or 3 carbon atoms. (4) The fluorophosphate ester is preferably at least one selected from the group consisting of tris(2,2,2-trifluoroethyl)phosphate, bis(2,2,2-trifluoroethyl)methylphosphate, and bis(2,2,2-trifluoroethyl)ethylphosphate. The fluorophosphate ester easily imparts high flame retardancy. Further, the fluorophosphate ester easily further improves a cycle characteristic.

(5) A sum of a content of the fluorophosphate ester and a content of the PC in the non-aqueous solvent is preferably 80 mass % or more. In this case, the content of the fluorophosphate ester and the PC in the electrolytic solution can relatively be increased so that the effect of improving flame retardancy and charge-discharge characteristics (cycle characteristic and rate characteristic) can easily be obtained.

In a preferable embodiment, (6) a content of the fluorophosphate ester in the non-aqueous solvent is 10 to 40 mass %. In a further preferable embodiment, (7) a content of the fluorophosphate ester in the non-aqueous solvent is 10 to 35 mass %. The electrolytic solutions of these embodiment can further enhance the effect of improving charge-discharge characteristics while ensuring high flame retardancy.

(8) Another embodiment of the present invention relates to a sodium-ion secondary battery including: a positive electrode; a negative electrode; a separator interposed between the positive electrode and the negative electrode; and the electrolytic solution described above. The sodium-ion secondary battery includes the electrolytic solution described above, and therefore can achieve high cycle characteristic and rate characteristic. Further, since the sodium ion secondary battery of this embodiment has high flame retardancy, the sodium ion secondary battery also has excellent safety.

### DETAILED DESCRIPTION OF EMBODIMENTS OF THE INVENTION

Specific examples of the electrolytic solution for the sodium-ion secondary battery and the sodium-ion secondary battery of the embodiments of the present invention will be described below with reference to the drawing appropriately. The present invention is not limited to these examples and is defined by the attached claims. The scope of the present invention is intended to include all modifications within the scope of the claims and equivalents thereof.

1. Electrolytic Solution for Sodium-Ion Secondary Battery

The electrolytic solution for the sodium-ion secondary battery of the embodiment of the present invention includes a sodium salt and a non-aqueous solvent.

(Sodium Salt)

Since the sodium salt dissociates in the electrolytic solution to form a sodium ion (hereinafter, also referred to as a “first cation”) and an anion (hereinafter, also referred to as a “first anion”), the electrolytic solution has sodium ion conductivity.

The kind of the first anion constituting the sodium salt is not particularly limited. Examples of the first anion include a fluorine-containing acid anion, a chlorine-containing acid anion, an oxalate group-containing oxyacid anion, a fluoroalkane sulfonic acid anion, bissulfonylamide anion, and the like. These sodium salts can be used alone or used in admixture of two or more kinds of sodium salts different in the first anion.

Examples of the fluorine-containing acid anion include: a fluorine-containing phosphoric acid anion such as a hexafluorophosphoric acid ion (PF₆⁻); a fluorine-containing boric acid anion such as a tetrafluoroboric acid ion (BF₄⁻); and the like.

Example of the chlorine-containing acid anion include: a perchloric acid ion (ClO₄⁻), and the like.

Examples of the oxalate group-containing oxyacid anion include: an oxalate borate ion such as a bis(oxalate)borate ion (B(C₂O₄)₂⁻); an oxalate phosphate ion such as a tris(oxalate)phosphate ion (P(C₂O₄)₃⁻); and the like.

Example of the fluoroalkanesulfonic acid anion include a trifluoromethanesulfonic acid ion (CF₃SO₃⁻), and the like.

Examples of the bissulfonylamide anion include: a bis(fluorosulfonyl)amide anion (FSA); a (fluorosulfonyl)(perfluoroalkylsulfonyl)amide anion such as (FSO₂)(CF₃SO₂)N⁻; a bis(perfluoroalkylsulfonyl)amide anion such as a bis(trifluoromethylsulfonyl)amide anion (TFSA), N(SO₂CF₃)₂⁻), or N(SO₂C₂F₅)₂⁻; and the like. Among them, FSA and/or TFSA, more specifically, FSA, TFSA, and a mixture of FSA and TFSA are particularly preferred.

The concentration of the sodium salt or sodium ions in the electrolytic solution can appropriately be selected from, for example, 0.2 to 10 mol/L, preferably 0.2 to 5 mol/L, more preferably 0.2 to 2.5 mol/L.

(Non-Aqueous Solvent)

A conventional sodium-ion secondary battery including an organic electrolytic solution containing an organic solvent can operate at low temperature. However, it is difficult for the sodium secondary battery to achieve cycle stability at high temperature. When an ionic liquid is used as an electrolyte of an electrolytic solution of a sodium-ion secondary battery, cycle stability at high temperature can be achieved, but a utilization rate at low temperature (rate characteristic at low temperature) is low.

According to this embodiment of the present invention, a non-aqueous solvent containing 5 to 50 mass % of a fluorophosphate ester (first solvent) and PC (second solvent) is used as a solvent of the electrolytic solution. Therefore, the electrolytic solution of this embodiment can ensure high flame retardancy and high ion conductivity. This makes it possible to enhance the flame retardancy of a sodium-ion secondary battery. Further, a sodium secondary battery including the non-aqueous solvent as a solvent of its electrolytic solution can achieve cycle stability at high temperature and a higher rate of utilization at low temperature.

A flash point of the electrolytic solution is preferably 70° C. Preferably, the electrolytic solution has no flash point. When the flash point is 70° C. or higher, the electrolytic solution is classified as Class III petroleum or Class IV petroleum. Therefore, the electrolytic solution of this embodiment can ensure higher safety than an electrolytic solution for a lithium-ion secondary battery generally classified as Class II petroleum.

(Fluorophosphate)

The fluorophosphate ester can be a compound in which one or two of three possible esterification sites (—OH groups) of orthophosphoric acid is/are esterified, but is preferably a compound in which all the possible esterification sites are esterified, that is, a compound represented by the following formula (I).

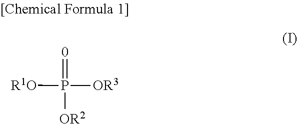

(wherein R¹, R², and R³ are each independently an alkyl group or an alkyl fluoride group, and at least one of R¹, R², and R³ is an alkyl fluoride group).

Two or three of R¹ to R³ can be the same, R¹ to R³ can be all the same, or R¹ to R³ can be different from one another. Examples of the alkyl group represented by R¹ to R³ include an alkyl group having 1 to 6 carbon atoms such as methyl group, ethyl group, n-propyl group, isopropyl group, n-butyl group, sec-butyl group, tert-butyl group, and the like. Examples of the alkyl fluoride group include an alkyl fluoride groups corresponding to the alkyl groups, that is, a fluoroalkyl group having 1 to 6 carbon atoms. The number of carbon atoms of each of the alkyl group and the fluoroalkyl group is preferably 1 to 3, more preferably 2 or 3.

The number of fluorine atoms in the alkyl fluoride group is not particularly limited and can be appropriately selected depending on the number of carbon atoms of the alkyl fluoride group. The number of fluorine atoms contained in the alkyl fluoride group can be selected from, for example, 1 to 6. The number of fluorine atoms contained in the alkyl fluoride group can be 1 to 4. From the viewpoint of flame retardancy and charge-discharge characteristics, the number of fluorine atoms in the alkyl fluoride group is preferably two or more, more preferably 2 to 4, even more preferably 2 or 3. Among the above-mentioned fluorophosphate esters, a polyfluoroalkylphosphate having a polyfluoroalkyl group is preferred.

The alkyl fluoride group can have a fluorine atom on any carbon atom constituting the alkyl fluoride group, but preferably has a fluorine atom on a carbon atom as far as possible from a phosphorus atom of the fluorophosphate ester. For example, when the alkyl fluoride group is an ethyl fluoride group, a fluorine atom is preferably on a 2-position carbon atom of an ethyl group. When the alkyl fluoride group is an n-propyl fluoride group, a fluorine atom is preferably on a 3-position carbon atom of an n-propyl group.

The number of alkyl fluoride groups (e.g., a polyfluoroalkyl group, and the like) can be selected from 1 to 3. From the viewpoint of ensuring high flame retardancy and excellent charge-discharge characteristics, two or three of R¹, R², and R³ are preferably alkyl fluoride groups (e.g., polyfluoroalkyl groups) and the rest is preferably an alkyl group. Examples of the polyfluoroalkyl group include: a difluoroalkyl group having 1 to 3 carbon atoms such as difluoromethyl group or 2,2-difluoroethyl group; trifluoroalkyl group having 1 to 3 carbon atoms such as trifluoromethyl group, 2,2,2-trifluoroethyl group, or 3,3,3-trifluoropropyl group; a tetrafluoroalkyl group having 2 or 3 carbon atoms such as 2,2,3,3-tetrafluoropropyl group; and the like.

From the viewpoint of ensuring high flame retardancy and excellent charge-discharge characteristics (e.g., a cycle characteristic, a rate characteristic), among of the above fluorophosphate esters, preferred is at least one selected from the group consisting of tris(2,2,2-trifluoroethyl) phosphate (TFEP), bis(2,2,2-trifluoroethyl) methylphosphate (TFEMP), and bis(2,2,2-trifluoroethyl) ethylphosphate (TFEEP). From the viewpoint of further enhancing a rate characteristic, TFEMP and/or TFEEP, more specifically, TFEMP, TFEEP, or a mixture of TFEMP and TFEEP is preferably used.

The content of the fluorophosphate ester in the non-aqueous solvent is 5 mass % or higher, preferably 10 mass % or higher, more preferably 20 mass % or higher, even more preferably 25 mass % or higher, from the viewpoint of enhancing flame retardancy. The content of the fluorophosphate ester in the non-aqueous solvent is 50 mass % or less, preferably 40 mass % or less, more preferably 35 mass % or less, even more preferably 30 mass % or less. These lower limits and upper limits can be arbitrarily combined. The content of the fluorophosphate ester in the non-aqueous solvent can be 10 to 50 mass %, 10 to 40 mass %, 10 to 35 mass %, or 20 to 40 mass %.

When a non-aqueous solvent containing a fluorophosphate ester in such a content and PC is used in the case of a lithium-ion secondary battery, there is a case where it is difficult to perform charge and discharge. However, in the case of a sodium-ion secondary battery, even when such a non-aqueous solvent is used, excellent cycle characteristic and rate characteristic are achieved.

(PC)

The content of the PC (second solvent) in the non-aqueous solvent is preferably 95 mass % or less. The content of the PC in the non-aqueous solvent is preferably 20 mass % or higher, more preferably 50 mass % or higher, even more preferably 60 mass % or higher. When the PC content is within the above range, high flame retardancy and high cycle characteristic and rate characteristic are easily balanced.

(Third Solvent)

The non-aqueous solvent can further contain a solvent (third solvent) other than the fluorophosphate ester and the PC. Examples of the third solvent include a known solvent used as a solvent of an electrolytic solution of a sodium-ion secondary battery, such as an organic solvent, an ionic liquid, a mixture of an organic solvent and an ionic liquid, and a phosphate (specifically, a phosphate having no fluorine atom). These third solvents can be used alone or used in admixture of two or more kinds thereof. The ionic liquid is synonymous with a salt in a molten state (molten salt) at at least 100° C. or lower. The ionic liquid is a liquid ionic material composed of an anion and a cation. Although among the above-mentioned sodium salts, for example, a salt composed of a sodium ion and a bissulfonylamide anion, is generally sometimes classified as ionic liquids, it is to be noted herein that the sodium salt is not contained in the ionic liquid for the sake of convenience.

The organic solvent is not particularly limited, and a known organic solvent for use in a sodium-ion secondary battery (organic solvent other than PC) can be used. From the viewpoint of ion conductivity, preferred examples of the organic solvent other than PC include: a cyclic carbonate other than PC, the cyclic carbonate including ethylene carbonate (EC), fluoroethylene carbonate, difluoroethylene carbonate, vinyl ethylene carbonate, vinylene carbonate, or butylene carbonate; a linear carbonate such as dimethyl carbonate, diethyl carbonate (DEC), or ethyl methyl carbonate; a cyclic ester such as γ-butyrolactone, δ-valerolactone, or ε-caprolactone; an ether; and the like. These organic solvents can be used alone or used in admixture of two or more kinds thereof. Examples of the ether include a linear or cyclic ether such as a glyme compound (e.g., tetraglyme), a fluorine-containing ether, and a crown ether.

From the viewpoint of further enhancing a cycle characteristic and a rate characteristic, a non-aqueous solvent containing a cyclic carbonate other than PC and/or a linear carbonate, more specifically, a non-aqueous solvent containing a cyclic carbonate other than PC, a non-aqueous solvent containing a linear carbonate, or a non-aqueous solvent containing a mixture of a cyclic carbonate other than PC and a linear carbonate can be used. Further, from the viewpoint of further enhancing a cycle characteristic and a rate characteristic, a non-aqueous solvent containing a cyclic carbonate, a cyclic ester, and/or an ether, more specifically, a non-aqueous solvent containing a cyclic carbonate other than PC, a non-aqueous solvent containing a cyclic ester, a non-aqueous solvent containing an ether, a non-aqueous solvent containing a mixture of a cyclic carbonate other than PC, a cyclic ester, and an ether, a non-aqueous solvent containing a mixture of a cyclic carbonate other than PC and a cyclic ester, a non-aqueous solvent containing a mixture of a cyclic carbonate other than PC and an ether, or a non-aqueous solvent containing a mixture of a cyclic ester and an ether is also preferably used.

Among the third solvents, the ionic liquid contains a cation (hereinafter, also referred to as a “second cation”) other than a sodium ion and an anion (hereinafter, also referred to as a “second anion”). Examples of the second cation include an inorganic cation other than a sodium ion, an organic cation, and the like. The ionic liquid can contain, as a second cation, one kind of cation other than a sodium ion, or can contain as a second cation, a mixture of two or more kinds of cations other than a sodium ion.

Examples of the organic cation include: a nitrogen-containing onium cation such as a cation derived from an aliphatic amine, an alicyclic amine or an aromatic amine (e.g., a quaternary ammonium cation), or a cation having a nitrogen-containing hetero ring (i.e., a cation derived from a cyclic amine); a sulfur-containing onium cation; a phosphorus-containing onium cation; and the like. Among these nitrogen-containing organic onium cations, a quaternary ammonium cation and a cation having a pyrrolidine skeleton, a pyridine skeleton or an imidazole skeleton as a nitrogen-containing heterocyclic skeleton are particularly preferred.

Specific examples of the nitrogen-containing organic onium cation include: a tetraalkylammonium cation such as tetraethylammonium cation (TEA) or methyltriethylammonium cation (TEMA); 1-methyl-1-propylpyrrolidinium cation (MPPY or Py13) or 1-butyl-1-methylpyrrolidinium) cation (MBPY or Py14; and 1-ethyl-3-methylimidazolium cation (EMI) and/or 1-butyl-3-methylimidazolium cation (BMI).

Examples of the inorganic cation include an alkali metal ion other than sodium ion (e.g., potassium ion, or the like), an alkaline-earth metal ion (e.g., magnesium ion, calcium ion, or the like), ammonium ion, and the like.

It is preferred that the second cation contains an organic cation. The use of an ionic liquid containing an organic cation makes it easy to reduce the viscosity of the electrolytic solution. Therefore, sodium ion conductivity is easily enhanced and high capacity is easily ensured. An organic cation and an inorganic cation can be contained as the second cations.

As the second anion, a bissulfonylamide anion is preferably used. The bissulfonylamide anion can be appropriately selected from those exemplified above with reference to the sodium salt. Among these bissulfonylamide anions, FSA and/or TFSA, more specifically, FSA, TFSA, and a mixture of FSA and TFSA are particularly preferred.

Specific examples of the ionic liquid include a salt of Py13 and FSA (Py13-FSA), a salt of Py13 and TFSA (Py13-TFSA), a salt of Py14 and FSA (Py14-FSA), a salt of Py14 and TFSA (Py14-TFSA), a salt of BMI and FSA (BMI-FSA), a salt of BMI and TFSA (BMI-TFSA), a salt of EMI and FSA (EMI-FSA), a salt of EMI and TFSA (EMI-TFSA), a salt of TEMA and FSA (TEMA-FSA), a salt of TEMA and TFSA (TEMA-TFSA), a salt of TEA and FSA (TEA-FSA), and a salt of TEA and TFSA (TEA-TFSA). These salts can be used alone or used in admixture of two or more kinds thereof.

Among the third solvents, examples of the phosphate include: a trialkylphosphate (e.g., a trialkylphosphate having an alkyl group having 1 to 6 carbon atoms) such as trimethylphosphate (TMP) or triethylphosphate (TEP); and a triarylphosphate (e.g., a triarylphosphate having an aryl group having 6 to 10 carbon atoms) such as triphenylphosphate or tritolylphosphate. These phosphates can be used alone or used in admixture of two or more kinds thereof. Among these phosphates, a trialkylphosphate having an alkyl group having 1 to 4 carbon atoms, such as TMP or TEP, is preferred, and a trialkylphosphate having an alkyl group having 1 to 3 carbon atoms is more preferred.

Among the third solvents, the organic solvent generally has low flame retardancy and a low flash point. Even when its non-aqueous solvent contains such an organic solvent, the electrolytic solution of this embodiment of the present invention contains a predetermined amount of fluorophosphate ester. Therefore, flame retardancy can be improved. From the viewpoint of a low-temperature characteristic, a non-aqueous solvent containing an organic solvent is preferably used. From the viewpoint of inhibiting decomposition of the electrolytic solution as much as possible, a non-aqueous solvent containing an ionic liquid is preferably used. A non-aqueous solvent containing an ionic liquid and an organic solvent can be used as the non-aqueous solvent of the electrolytic solution of this embodiment. The use of a phosphate makes it easy to further improve a cycle characteristic and a rate characteristic.

The sum of a content of the fluorophosphate ester and a content of the PC in the non-aqueous solvent can be preferably 70 mass % or higher, more preferably 80 mass % or higher, even more preferably 90 mass % or higher. If necessary, the non-aqueous solvent can be composed of only the fluorophosphate ester and the PC.

If necessary, the electrolytic solution can contain an additive in addition to the sodium salt and the non-aqueous solvent. The sum of a content of the sodium salt and a content of the non-aqueous solvent in the electrolytic solution can be preferably 70 mass % or higher, more preferably 80 mass % or higher, even more preferably 90 mass % or higher. When the sum of a content of the sodium salt and a content of the non-aqueous solvent in the electrolytic solution is within the above range, the content of the fluorophosphate ester and the PC in the electrolytic solution can relatively be increased so that the effect of improving flame retardancy and charge-discharge characteristics can easily be obtained.

2. Sodium-Ion Secondary Battery

The sodium-ion secondary battery of the embodiment of the present invention includes: a positive electrode; a negative electrode; a separator interposed between them; and the electrolytic solution described above.

Hereinbelow, components of the battery other than the electrolytic solution will be described in more detail.

(Positive Electrode)

The positive electrode includes a positive electrode active material. The positive electrode can include a positive electrode current collector and a positive electrode active material (or a positive electrode mixture) supported by the positive electrode current collector.

The positive electrode current collector can be a metallic foil or a metallic porous body (e.g., a metallic fiber non-woven fabric, a metallic porous sheet, or the like). As the metallic porous body, a metallic porous body having a three-dimensional mesh-like skeleton (especially, a hollow skeleton) can also be used. From the viewpoint of stability at a positive electrode potential, the material of the positive electrode current collector is preferably aluminum, an aluminum alloy, or the like.

Examples of the positive electrode active material include a material that occludes and releases (or intercalates and deintercalates) sodium ions (i.e., a material that develops a capacity due to a faradaic reaction), and the like. Examples of such a material include a compound containing, as constituent atoms, an alkali metal atom (e.g., sodium atom, potassium atom) and a transition metal atom (e.g., a transition metal atom in the fourth period of the periodic table, such as chromium atom, manganese atom, iron atom, cobalt atom, or nickel atom). At least either some of alkali metal atoms or some of transition metal atoms contained in the crystalline structure of such a compound can be replaced with typical metal atoms such as aluminum atoms.

The positive electrode active material preferably contains a transition metal compound such as a sodium-containing transition metal compound. Examples of the transition metal compound include a known transition metal compound that can be used as a positive electrode active material of a sodium-ion secondary battery, such as a sulfide, an oxide, a sodium transition metal oxyacid salt, or a sodium-containing transition metal halide. Examples of the sulfide include: a transition metal sulfide such as TiS₂ or FeS₂; a sodium-containing transition metal sulfide such as NaTiS₂, and the like. Examples of the oxide include a sodium-containing transition metal oxide such as sodium chromite (NaCrO₂), sodium nickel manganate (e.g., NaNi_{0.5}Mn_{0.5}O₂, Na_{2/3}Ti_{1/6}Ni_{1/3}Mn_{1/2}O₂, or the like), sodium iron cobaltate (e.g., NaFe_{0.5}Co0.5O₂, or the like), and sodium iron manganate (e.g., Na_{2/3}Fe_{1/3}Mn_{2/3}O₂, or the like); and the like. Example of the sodium-containing transition metal halide include Na₃FeF₆, and the like. Among them, sodium chromite and sodium iron manganate are preferred. At least either some of chromium atoms or some of sodium atoms contained in the crystalline structure of sodium chromite can be replaced with other atoms. At least any of some of iron atoms, some of manganese atoms, and some of sodium atoms contained in the crystalline structure of sodium iron manganate can be replaced with other atoms.

The positive electrode mixture can further contain a conductive auxiliary agent and/or a binder in addition to the positive electrode active material. The positive electrode is obtained by coating or filling the positive electrode current collector with the positive electrode mixture, drying the positive electrode mixture, and if necessary compressing (or rolling) the resulting dried product in its thickness direction. The positive electrode mixture is usually used in the form of slurry containing a dispersion medium.

Examples of the conductive auxiliary agent include carbon black, graphite, carbon fiber, and the like. These conductive auxiliary agents can be used alone or used in admixture of two or more kinds thereof.

Examples of the binder include a fluorocarbon resin, a polyolefin resin, a rubbery polymer, a polyamide resin, a polyimide resin (e.g., polyamideimide, or the like), a cellulose ether, and the like. These binders can be used alone or used in admixture of two or more kinds thereof.

Examples of the dispersion medium to be used include an organic solvent such as N-methyl-2-pyrrolidone (NMP) and water.

(Negative Electrode)

The negative electrode contains a negative electrode active material. The negative electrode can contain a negative electrode current collector and a negative electrode active material (or a negative electrode mixture) supported by the negative electrode current collector.

Similarly to the positive electrode current collector, the negative electrode current collector can be a metallic foil or a metallic porous body. The material of the negative electrode current collector is preferably copper, a copper alloy, nickel, a nickel alloy, stainless steel or the like, because such a material does not form an alloy with sodium and is stable at a negative electrode potential.

Examples of the negative electrode active material include a material that reversibly occludes and releases (or intercalates and deintercalates) sodium ions and a material that forms an alloy with sodium. All these materials develop a capacity due to a faradaic reaction.

Examples of such a negative electrode active material include: a metal or semimetal such as sodium, titanium, zinc, indium, tin, or silicon; an alloy obtained from the metal or semimetal; a compound of the metal or semimetal; and a carbonaceous material. The alloy can further contain another alkali metal or alkaline-earth metal in addition to the metal or semimetal.

Examples of the compound of the metal or semimetal include: a lithium-containing titanium oxide such as lithium titanate (e.g., Li₂Ti₃O₇, Li₄Ti₅O₁₂, or the like); a sodium-containing titanium oxide such as sodium titanate (e.g., Na₂Ti₃O₇, Na₄Ti₅O₁₂, or the like); and the like. At least either some of titanium atoms or some of lithium atoms contained in the crystalline structure of the lithium-containing titanium oxide can be replaced with other atoms. At least either some of titanium atoms or some of sodium atoms contained in the crystalline structure of the sodium-containing titanium oxide can be replaced with other atoms.

Examples of the carbonaceous material include graphitizable carbon (soft carbon), non-graphitizable carbon (hard carbon), and the like. These carbonaceous materials can be used alone or used in admixture of two or more kinds thereof.

Among these materials, a compound of the metal or semimetal (e.g., a sodium-containing titanium oxide, or the like), a carbonaceous material (hard carbon) and the like are preferred.

These negative electrode active materials can be used alone or used in admixture of two or more kinds thereof.

The negative electrode can be formed by, for example, coating or filling the negative electrode current collector with the negative electrode mixture containing the negative electrode active material, drying the negative electrode mixture, and compressing (or rolling) the resulting dried product in its thickness direction as in the case of the positive electrode. Alternatively, the negative electrode to be used can be obtained by forming, on the surface of the negative electrode current collector, a deposited film of the negative electrode active material by a gas phase method such as vapor deposition or sputtering. If necessary, the negative electrode active material can be preliminarily doped with sodium ions.

The negative electrode mixture can further contain a conductive auxiliary agent and/or a binder in addition to the negative electrode active material. The negative electrode mixture is usually used in the form of slurry containing a dispersion medium. Each of the conductive auxiliary agent, the binder, and the dispersion medium can be appropriately selected from those exemplified above with reference to the positive electrode.

(Separator)

Examples of the separator to be used include a microporous film made of a synthetic rein, a non-woven fabric, and the like.

The material of the separator can be selected in consideration of the operating temperature of the battery. Examples of the synthetic resin constituting the microporous film include a polyolefin resin, a polyphenylenesulfide resin, a polyamide resin (e.g., an aromatic polyamide resin or the like), a polyimide resin, and the like. When fiber constituting the non-woven fabric is made of a synthetic resin, the resin can be the same with the synthetic resin constituting the microporous film. The fiber constituting the non-woven fabric can be inorganic fiber such as glass fiber. The separator can contain an inorganic filler such as ceramic particles.

(Shape of Sodium Secondary Battery)

Examples of the shape of the sodium-ion secondary battery include a rectangular type, a cylindrical type, a laminate type, a coin type, a button type, and the like.

(Method for Producing Sodium Secondary Battery)

The sodium-ion secondary battery can be produced through the steps of, for example, (a) forming an electrode group with the use of a positive electrode, a negative electrode, and a separator interposed between the positive electrode and the negative electrode and (b) housing the electrode group and an electrolytic solution in a battery case. When the sodium-ion secondary battery is a coin- or button-type battery, the coin- or button-type battery can be produced through, for example, the following steps. First, either a positive electrode or a negative electrode is placed in a battery case. Then, the electrode placed in the battery case is covered with a separator. Then, an electrolytic solution is poured into the battery case. Next, the other electrode is placed in the battery case. Thereafter, the battery case is hermetically sealed.

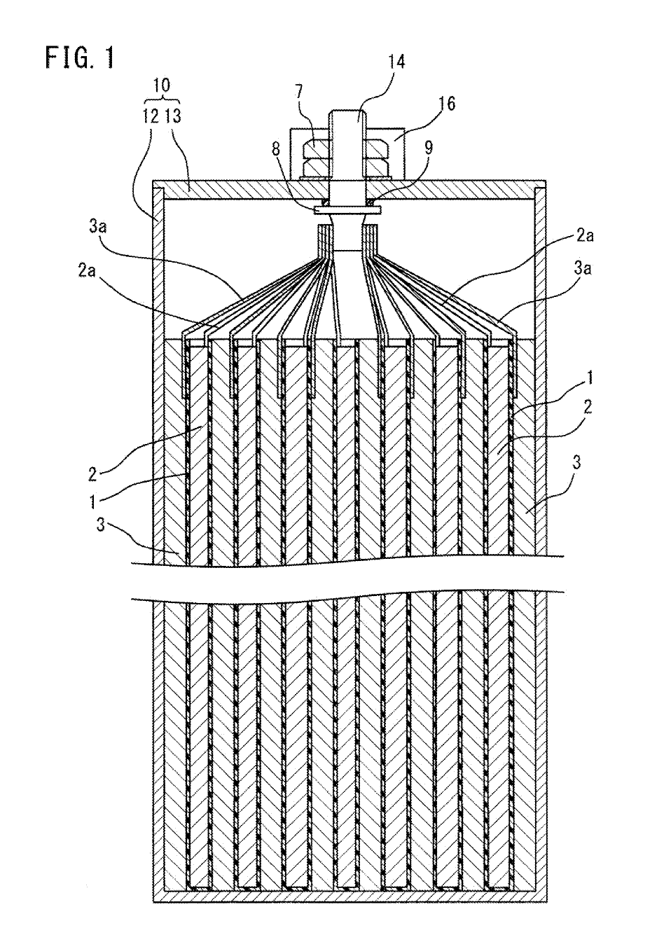

FIG. 1 is a longitudinal sectional view schematically showing a sodium-ion secondary battery of one embodiment of the present invention. The sodium-ion secondary battery includes a stack-type electrode group, an electrolytic solution (not shown), and a rectangular aluminum battery case 10 for housing them. The battery case 10 includes a case main body 12 having an upper opening and a closed bottom and a lid 13 that closes the upper opening.

When the sodium-ion secondary battery is assembled, an electrode group is formed by first stacking positive electrodes 2 and negative electrodes 3 with separators 1 being interposed between them. The formed electrode group is inserted into the case main body 12 of the battery case 10. Then, the step of pouring an electrolytic solution into the case main body 12 is performed to impregnate the electrode group with the electrolytic solution to fill the gaps between the separators 1 and the positive and negative electrodes 2 and 3 constituting the electrode group.

In the center of the lid 13, a safety valve 16 is provided to release gas generated inside the battery case 10 due to an increase in the inner pressure of the battery case 10. At a position close to one side of the lid 13 having the safety valve 16 in the center thereof, an external positive electrode terminal 14 is provided so as to pass through the lid 13, and at a position close to the other side of the lid 13, an external negative electrode terminal is provided so as to pass through the lid 13.

The stack-type electrode group is constituted from the positive electrodes 2 and the negative electrodes 3, each of which has a rectangular sheet shape, and the separators 1 interposed between them. In FIG. 1, each of the separators 1 is bag-shaped to envelop the positive electrode 2, but the form of the separator is not particularly limited. The positive electrodes 2 and the negative electrodes 3 are alternately arranged in their stacking direction in the electrode group.

At one end of each of the positive electrodes 2, a positive electrode lead piece 2a can be formed. The positive electrode lead pieces 2a of the positive electrodes 2 are tied together and connected to the external positive electrode terminal 14 provided in the lid 13 of the battery case 10 so that the positive electrodes 2 are connected in parallel. Similarly, at one end of each of the negative electrodes 3, a negative electrode lead piece 3a can be formed. The negative electrode lead pieces 3a of the negative electrodes 3 are tied together and connected to the external negative electrode terminal provided in the lid 13 of the battery case 10 so that the negative electrodes 3 are connected in parallel. The bundle of the positive electrode lead pieces 2a and the bundle of the negative electrode lead pieces 3a are preferably arranged on the left and right sides of one end face of the electrode group with a space between them to prevent contact between them.

Each of the external positive electrode terminal 14 and the external negative electrode terminal is columnar, and has a thread groove in at least a portion exposed to the outside. A nut 7 is engaged with the thread groove of each of the terminals. The nut 7 is fixed to the lid 13 by rotating the nut 7. Each of the terminals has a flange 8 provided in its portion to be housed inside the battery case 10 so that the flange 8 is fixed to the inner surface of the lid 13 through an O-ring gasket 9 by rotating the nut 7.

The electrode group is not limited to a stack-type one, and can be one formed by winding a positive electrode and a negative electrode with a separator being interposed between them. From the viewpoint of preventing the deposition of metallic sodium on the negative electrode, the negative electrode can be larger in size than the positive electrode.

A cylindrical- or laminate-type sodium secondary battery can be appropriately produced in the same manner as described above.

### EXAMPLES

Hereinbelow, the present invention will more specifically be described based on examples and comparative examples, but is not limited to the following examples.

### Example 1

(1) Preparation of Positive Electrodes

A positive electrode mixture paste was prepared by dispersing NaCrO₂ (positive electrode active material), acetylene black (conductive auxiliary agent), and polyvinylidene fluoride (binder) in NMP so that a ratio of positive electrode active material/conductive auxiliary agent/binder (mass ratio) was 90/5/5. The resulting positive electrode mixture paste was applied to both surfaces of an aluminum foil (10 cm long×10 cm wide, thickness: 20 μm), sufficiently dried, and rolled to prepare 100 positive electrode sheets each having a 60 μm-thick positive electrode mixture layer on each of both surfaces of the aluminum foil so that a total thickness was 140 μm. A lead piece for current collection was formed at one of the ends of one side of each of the positive electrodes.

(2) Preparation of Negative Electrodes

A negative electrode mixture paste was prepared by dispersing hard carbon (negative electrode active material) and polyamideimide (binder) in NMP so that a ratio of negative electrode active material/binder (mass ratio) was 95/5. The resulting negative electrode mixture paste was applied to both surfaces of a copper foil as a negative electrode current collector (10 cm long×10 cm wide, thickness: 20 μm), sufficiently dried, and rolled to prepare 99 negative electrode sheets (or negative electrode precursor sheets) each having a 65 μm-thick negative electrode mixture layer on each of both surfaces of the copper foil so that a total thickness was 150 μm. Further, two negative electrode sheets (or negative electrode precursor sheets) were prepared in the same manner as described above except that a negative electrode mixture layer was formed on only one of the surfaces of the negative electrode current collector. A lead piece for current collection was formed at one of the ends of one side of each of the negative electrodes.

(3) Assembly of Electrode Group

The positive electrodes, the negative electrodes, and separators were stacked so that the separators were interposed between the positive electrodes and the negative electrodes, to thereby prepare an electrode group. At this time, at one of the ends of the electrode group, the negative electrode having a negative electrode mixture layer on only one of the surfaces thereof was arranged so that the negative electrode mixture layer faced the positive electrode. At the other end of the electrode group, the negative electrode having a negative electrode mixture layer on only one of the surfaces thereof was arranged so that the negative electrode mixture layer faced the positive electrode. As the separators, bag-shaped microporous films (made of a polyolefin and having a thickness of 50 μm) were used, and the separators each containing the positive electrode therein and the negative electrodes were stacked.

(4) Preparation of Electrolytic Solution

An electrolytic solution was prepared by dissolving NaFSA in a non-aqueous solvent containing TFEP (first solvent) and PC (second solvent) [first solvent/second solvent (mass ratio)=50/50]. At this time, the concentration of NaFSA in the electrolytic solution was 1 mol/L.

(5) Assembly of Sodium-Ion Secondary Battery

The electrode group obtained in the above (3) and the electrolytic solution obtained in the above (4) were housed in an aluminum case main body. The leads connected to the positive electrodes of the electrode group were connected to an external positive electrode terminal provided on an aluminum lid, and the leads connected to the negative electrodes were connected to an external negative electrode terminal provided on the lid. Then, an opening of the case main body was covered with the lid to hermetically seal the case main body to complete a sodium-ion secondary battery with a nominal capacity of 26 Ah shown in FIG. 1.

(6) Evaluation

The following evaluations were performed by using the electrolytic solution obtained in the above (4) and the sodium-ion secondary battery obtained in the above (5).

(a) Flash Point of Electrolytic Solution

In accordance with JIS K 2265-2, the flash point of the electrolytic solution was measured with a Setaflash closed-cup flash point tester.

(b) Cycle Characteristic

A discharge capacity (initial discharge capacity) was measured by charging the sodium-ion secondary battery up to 3.4 V at a temperature of 25° C. at a current in a current rate of 0.5 C, and discharging the sodium-ion secondary battery down to 1.5 Vat a current in a current rate of 0.5 C. The charge and discharge cycle was repeated under the same conditions as described above. Then, a discharged capacity at the 200th cycle was measured to calculate the ratio of the discharge capacity to the initial discharge capacity defined as 100% (capacity maintenance rate).

(c) Rate Characteristic (Low-Temperature Rate Characteristic)

A discharge capacity C_{H} was measured by charging the sodium-ion secondary battery up to 3.4 V at a temperature of 40° C. at a current in a current rate of 0.1 C, and discharging the sodium-ion secondary battery down to 1.5 Vat a current in a current rate of 0.1 C.

The sodium-ion secondary battery was charged up to 3.4 V at a temperature of 40° C. at a current in a current rate of 0.1 C, and was discharged down to 1.5 V at a temperature of −10° C. at a current in a current rate of 0.1 C. A discharge capacity C_{L} at this time was determined to calculate the ratio (%) of the discharge capacity C_{L} to the discharge capacity C_{H} as an index of a rate characteristic.

### Examples 2 to 4

An electrolytic solution was prepared in the same manner as in Example 1 except that the mass ratio between TFEP and PC in the non-aqueous solvent was changed as shown in Table 2. A sodium-ion secondary battery was produced and evaluated in the same manner as in Example 1 except that the resulting electrolytic solution was used.

### Comparative Example 1

Positive electrodes were prepared in the same manner as in Example 1 except that LiCoO₂ was used instead of NaCrO₂.

An electrolytic solution was prepared in the same manner as in Example 1 except that LiFSA (lithium bis(fluorosulfonyl)amide) was used instead of NaFSA. The flash point of the electrolytic solution was evaluated in the same manner as in Example 1.

An electrode group was prepared in the same manner as in Example 1 except that the resulting positive electrodes were used, and a secondary battery was produced in the same manner as in Example 2 except that this electrode group and the above electrolytic solution were used. A cycle characteristic and a rate characteristic were evaluated in the same manner as in Example 1. At this time, a charge cutoff voltage and a discharge cutoff voltage were 4.2 V and 3.0 V, respectively. The secondary battery obtained in Comparative Example 1 is a lithium-ion secondary battery.

### Reference Example 1

An electrolytic solution was prepared in the same manner as in Example 1 except that a mixed solvent containing EC and DEC [EC:DEC (volume ratio)=1:1] was used instead of PC. A sodium-ion secondary battery was produced and evaluations were made in the same manner as in Example 1 except that the resulting electrolytic solution was used.

The results of Examples 1 to 4, Comparative Example 1, and Reference Example 1 are shown in Table 1. In Table 1, A1 to A4 correspond to Examples 1 to 4, B1 being Comparative Example 1, C1 being Reference Example 1, respectively.

TABLE 1

| | | Non-Aqueous Solvent | | | Flash | Cycle | Rate |
|---|---|---|---|---|---|---|---|
| | | Fluorophosphate Ester | | PC | Point | Characteristic | Characteristic |
| | Salt | (mass %) | | (mass %) | (° C.) | (%) | (%) |
| A1 | NaFSA | TFEP | 50 | 50 | None | 90 | 75 |
| A2 | | TFEP | 30 | 70 | None | 92 | 88 |
| A3 | | TFEP | 20 | 80 | None | 91 | 88 |
| A4 | | TFEP | 10 | 90 | 145 | 91 | 90 |
| B1 | LiFSA | TFEP | 30 | 70 | None | Impossible to Charge | Impossible to Charge |
| | | | | | | and Discharge | and Discharge |
| C1 | NaFSA | TFEP | 30 | (70*) | 34 | 56 | 90 |

*EC:DEC = 1:1(Volume Ratio)

As shown in Table 1, the sodium-ion secondary batteries of Examples achieved a high cycle characteristic of 90% or more and a high rate characteristic of more than 70%. The electrolytic solutions used in Examples have no flash point or a high flash point of 145° C., and are therefore excellent in flame retardancy. On the other hand, the lithium-ion secondary battery B1 of Comparative Example could not perform charge and discharge in spite of the fact that the non-aqueous solvent used was the same as that used in Example 2, and therefore its cycle characteristic and rate characteristic could not be evaluated. Unlike the battery B1 of Comparative Example, the battery C1 of Reference Example 1 using EC/DEC instead of PC can perform charge and discharge. Further, the battery C1 achieves a high rate characteristic almost the same as that of the corresponding battery A2 of Example. However, the cyclic characteristic of the battery C1 was lower than those of Examples. The reason why the cycle characteristic of the battery C1 was deteriorated is considered to be that a stable SEI film was not formed.

### Examples 5 and 6

An electrolytic solution was prepared in the same manner as in Example 3 except that a fluorophosphate ester shown in Table 2 was used instead of TFEP. A sodium-ion secondary battery was produced and evaluations were made in the same manner as in Example 2 except that the resulting electrolytic solution was used.

The results of Examples 5 and 6 are shown in Table 2. In Table 2, A5 and A6 correspond to Examples 5 and 6, respectively. In Table 2, the results of Example 2 are also shown.

TABLE 2

| | | Non-Aqueous Solvent | | | | Cycle | Rate |
|---|---|---|---|---|---|---|---|
| | | Fluorophosphate | | | Flash | Charac- | Charac- |
| | | Ester | | PC | Point | teristic | teristic |
| | Salt | (mass %) | | (mass %) | (° C.) | (%) | (%) |
| A2 | NaFSA | TFEP | 30 | 70 | None | 92 | 88 |
| A5 | | TFEMP | 30 | 70 | None | 91 | 93 |
| A6 | | TFEEP | 30 | 70 | None | 92 | 95 |

Each of the sodium-ion secondary batteries A5 and A6 of Examples also achieved a cycle characteristic comparable to that of the battery A2 of Example. The rate characteristic of each of the batteries A5 and A6 was significantly improved as compared to the battery A2.

### INDUSTRIAL APPLICABILITY

An electrolytic solution of one embodiment of the present invention can improve the cycle characteristic and rate characteristic of a sodium-ion secondary battery while ensuring high flame retardancy. A sodium-ion secondary battery including such an electrolytic solution is expected to be used as, for example, a domestic or industrial large power storage device or a power source for electric cars or hybrid cars.

### REFERENCE SIGNS LIST

1: Separator
2: Positive electrode
2a: Positive electrode lead piece
3: Negative electrode
3a: Negative electrode lead piece
7: Nut
8: Flange
9: Gasket
10: Battery case
12: Case main body
13: Lid
14: External positive electrode terminal
16: Safety valve

1. An electrolytic solution for a sodium-ion secondary battery, the solution having sodium-ion conductivity, and comprising a sodium salt and a non-aqueous solvent, wherein
the non-aqueous solvent comprises a fluorophosphate ester and propylene carbonate, and
a content of the fluorophosphate ester in the non-aqueous solvent is 5 to 50 mass %.

2. The electrolytic solution for a sodium-ion secondary battery according to claim 1, wherein the solution has no flash point.

3. The electrolytic solution for a sodium-ion secondary battery according to claim 1, wherein the fluorophosphate ester is a polyfluoroalkylphosphate having 1 to 3 polyfluoroalkyl groups, and
wherein each of the 1 to 3 polyfluoroalkyl groups is a difluoroalkyl group having 1 to 3 carbon atoms, a trifluoroalkyl group having 1 to 3 carbon atoms, or a tetrafluoroalkyl group having 2 or 3 carbon atoms.

4. The electrolytic solution for a sodium-ion secondary battery according to claim 1, wherein the fluorophosphate ester is at least one selected from the group consisting of tris(2,2,2-trifluoroethyl)phosphate, bis(2,2,2-trifluoroethyl)methylphosphate, and bis(2,2,2-trifluoroethyl)ethylphosphate.

5. The electrolytic solution for a sodium-ion secondary battery according to claim 1, wherein the sum of the content of the fluorophosphate ester and a content of the propylene carbonate in the non-aqueous solvent is 80 mass % or more.

6. The electrolytic solution for a sodium-ion secondary battery according to claim 1, wherein the content of the fluorophosphate ester in the non-aqueous solvent is 10 to 40 mass %.

7. The electrolytic solution for a sodium-ion secondary battery according to claim 1, wherein the content of the fluorophosphate ester in the non-aqueous solvent is 10 to 35 mass %.

8. A sodium-ion secondary battery comprising: a positive electrode; a negative electrode; a separator interposed between the positive electrode and the negative electrode; and the electrolytic solution according to claim 1.
